(19) United States
(12) Patent Application Publication
(10) Pub. No.: US 2010/0161420 A1
(43) Pub. Date: Jun. 24, 2010

(54) SYSTEM AND METHOD FOR PROVIDING ADVERTISEMENT LEAD CALLING

(75) Inventor: Edward W. Mandel, Frisco, TX (US)

Correspondence Address: CARSTENS & CAHOON, LLP, P O BOX 802334, DALLAS, TX, 75380, US

(73) Assignee: NEXPLORE TECHNOLOGIES, INC., Frisco, TX (US)

(21) Appl. No.: 12/348,679

(22) Filed: Jan. 5, 2009

Related U.S. Application Data
(63) Continuation-in-part of application No. 12/348,653, filed on Jan. 5, 2009.
Application No. 12/348,653 is a continuation-in-part of application No. 12/340,195, filed on Dec. 19, 2008.

(51) Int. Cl. G06Q 30/00

(52) U.S. Cl. 705/14.55

(57) ABSTRACT

A system and method for providing advertisement lead calling in a networked environment. The system provides an advertisement contact module, a call request module, and a request transmission module. The user views an advertisement that he or she is interested in. An icon, placed proximate the ad by the system, allows the user to request additional information concerning the ad. The system generates a pop-up window in response to the user's request, whereby the user enters his or her contact information. The system then transmits the information request to the advertiser or the advertiser's representative to facilitate contact between the two. The user is notified as to the status of the transmission (pending or complete).

### CROSS-REFERENCE TO RELATED APPLICATIONS

This application is a continuation-in-part of U.S. patent application Ser. No. 12/348,653, which was filed on Jan. 5, 2009, which is also a continuation-in-part of U.S. patent application Ser. No. 12/340,195, which was filed on Dec. 19, 2008.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

The present invention relates to web advertising services, and more specifically to web advertising services that facilitate contact between an advertiser and a prospective customer through the exchange of contact information.

2. Description of Related Art Including Information Disclosed Under 37 CFR 1.97 and 1.98

The more quickly you can get a potential customer in contact with an advertiser, the greater the likelihood that the potential customer becomes a customer. Prior solutions only provide a link to the website or perhaps a phone number or e-mail address in the ad. Worse yet, most prior solutions require the potential customer to go to the advertiser's website to search for contact information.

### BRIEF SUMMARY OF THE INVENTION

The present invention provides a method, system, and computer software for providing advertisement lead calling associated with a displayed ad in a networked environment. The system provides an advertisement contact module, a call request module, and a request transmission module.

The user views, in his or her Web browser, an advertisement that he or she is interested in. An icon, placed proximate the ad by the system, allows the user to request additional information concerning the ad. Upon receiving such a request, the system generates a pop-up window whereby the user enters his or her contact information. The system then transmits the information request to the advertiser or the advertiser's representative to facilitate contact between the two. The user is notified as to the status of the transmission (pending or complete).

### BRIEF DESCRIPTION OF THE SEVERAL VIEWS OF THE DRAWING(S)

The present invention will be more fully understood by reference to the following detailed description of the preferred embodiments of the present invention when read in conjunction with the accompanying drawings, wherein:

FIG. 1 exemplifies a diagram of an advertisement lead calling system in a networked environment, in accordance with principles of the present invention;

FIG. 2 exemplifies a diagram of a method for providing advertisement lead calling, in accordance with principles of the present invention; and

FIG. 3 contains a screen shot of advertisements having an advertisement lead calling icon, in accordance with principles of the present invention.

The above figures are provided for the purpose of illustration and description only, and are not intended to define the limits of the disclosed invention. Use of the same reference number in multiple figures is intended to designate the same or similar parts. Furthermore, if and when the terms “top,” “bottom,” “first,” “second,” “upper,” “lower,” “height,” “width,” “length,” “end,” “side,” “horizontal,” “vertical,” and similar terms are used herein, it should be understood that these terms have reference only to the structure shown in the drawing and are utilized only to facilitate describing the particular embodiment. The extension of the figures with respect to number, position, relationship, and dimensions of the parts to form the preferred embodiment will be explained or will be within the skill of the art after the following teachings of the present invention have been read and understood.

### DETAILED DESCRIPTION OF THE INVENTION

In the following discussion, numerous specific details are set forth to provide a thorough understanding of the present invention. However, it will be obvious to those skilled in the art that the present invention may be practiced without such specific details. In other instances, well-known elements have been illustrated in schematic or block diagram form in order not to obscure the present invention in unnecessary detail. Additionally, for the most part, details concerning the Internet, digital content, and the like have been omitted inasmuch as such details are not considered necessary to obtain a complete understanding of the present invention, and are considered to be within the skills of persons of ordinary skill in the relevant art.

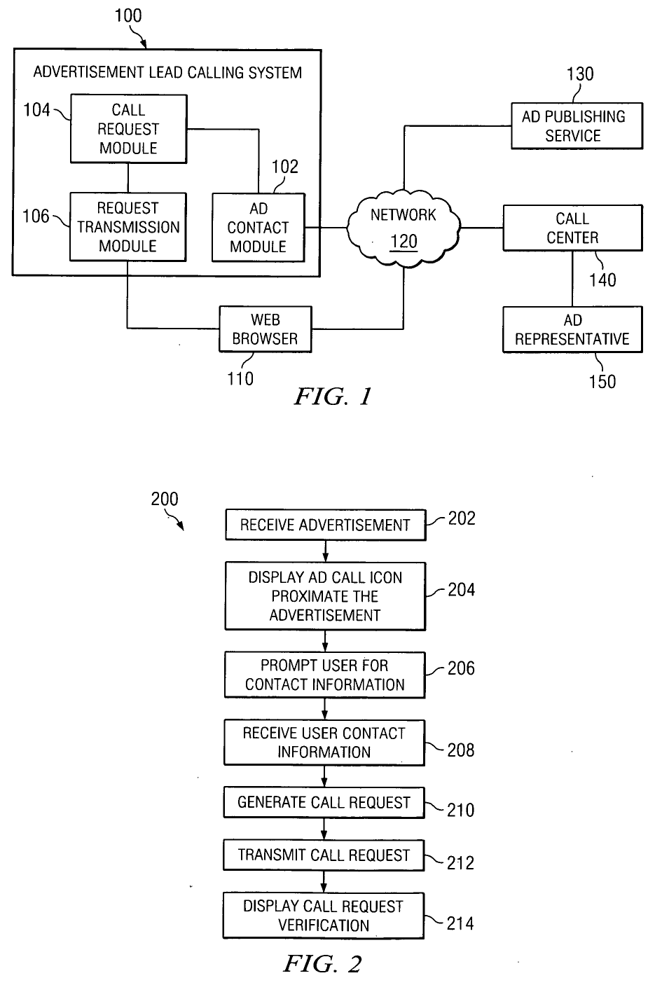

Referring to FIG. 1, there is shown a diagram of a live-interaction content rendering system (100) for providing live-interaction content associated with an advertisement over a network, in accordance with principles of the present invention. The system (100) is part of an application adapted to provide search results and advertisements associated with a search term. The application can be resident on a computer, a website, blog, forum, aggregator, and other suitable web-enabled application. The system (100) is preferably implemented in hardware, software, or a suitable combination of hardware and software thereof and may comprise one or more software systems operating on a digital signal processing platform or other suitable processing platforms.

As used herein, “hardware” can include a combination of discrete components, an integrated circuit, a microprocessor, a controller, a microcontroller, an application-specific integrated circuit (ASIC), an electronic data processor, a computer, a field programmable gate array, or other suitable hardware connectable for interfacing with a network, such as the Internet, considered to be well-known in the art. As used herein, “software” can include one or more objects, agents, threads, lines of code, subroutines, separate software applications, two or more lines of code or other suitable software structures operating in two or more software applications or on two or more processors, or other suitable hardware structures. Furthermore, it is considered that the design, development, and implementation details of all such hardware and software would be apparent to a person having ordinary skill in the art based upon a review of the present description of the invention. In one embodiment, software can include one or more lines of code or other suitable software structures operating in a general purpose software application, such as an operating system, and one or more lines of code or other suitable software structures operating in a specific purpose software application.

The system (100) is operably coupled to web-browser (110), advertisement publishing service (130), call center (140), and advertisement representative (150) by network (120). The network can be a WAN, MAN, LAN, PAN, and other suitable configuration. The system (100) is adapted to generate a communication request to provide live-interaction with a contact having information about an advertisement displayed in web-browser (110) and generates code adapted to instantiate a call request for the advertisement representative (150), of the call center (140), associated with advertisement contact information. The system (100) in this embodiment also includes advertisement contact module (102), call request module (104), and request transmission module (106).

The advertisement contact module (102) is adapted to receive advertisements from the advertisement publishing service (130) and parse out the information contained in the advertisement. In one embodiment, the advertisements are received as an XML transaction. In a second embodiment, the advertisements are received as a JSON transaction. In a third embodiment, the advertisement information parsed is contact information for the advertiser. The contact information can include entries such as an e-mail address or generated e-mail address alias (for privacy), instant messaging address, text messaging number, VoIP Internet number, and other suitable contact information. The advertisement contact module (102) can be achieved with an application programming interface (API), a network connection, a network transfer protocol, HTML, DHTML, Java, JavaScript, Dojo, Ruby, Rails, other suitable formats and applications, or a suitable combination thereof.

The call request module (104) is adapted to request the user's call request information and generate a call request for the user. The user selects an ad call icon disposed proximate the ad and a first pop-up window prompts the user to enter her call request information, such as name, phone number, requested call time, time zone, and other relevant call request information. After the user enters a valid phone number, the call request module (104) generates a call request having the call request information and the ad identification number. In one embodiment, an XML transaction is generated having the call request. In a second embodiment, a JSON transaction is generated having the call request. In a third embodiment, a plain-text message is generated having the call request. In a fourth embodiment, a text message is generated having the call request. In a seventh embodiment, the call center (140) can be an advertiser's phone number. The call request module (102) can be achieved with an application programming interface (API), a network connection, a network transfer protocol, HTML, DHTML, Java, JavaScript, Dojo, Ruby, Rails, other suitable formats and applications, or a suitable combination thereof.

The request transmission module (106) is adapted to transmit the call request to the appropriate destination. The call request can be transmitted according to the transmission preference listed in the contact information associated with the ad. In one embodiment, the call request is transmitted to the call center (140) via a text message over any suitable network. In a second embodiment, the call request is transmitted to the call center (140) via e-mail. In a third embodiment, the call request is transmitted to the call center (140) via a network transfer protocol. In a fourth embodiment, the call request is transmitted to the call center (140) via a network transfer protocol based on a data request from another application. In a fifth embodiment, the data request can be the GET command or other suitable transfer request command. In a sixth embodiment, the call center (140) listed in the contact information associated with the ad is the destination of the call request. The request transmission module (102) can be achieved with an application programming interface (API), a network connection, a network transfer protocol, HTML, DHTML, Java, JavaScript, Dojo, Ruby, Rails, other suitable formats and applications, or a suitable combination thereof.

In operation, the user sees an ad that he or she is interested in and desires to communicate with the ad representative (150) about the ad. However, the user does not have the ability to use one of the plurality of other communication mechanisms available (i.e., chat, video-conference, or other suitable internet communication). The present embodiment allows him or her to request, instead, that the advertisement representative (150) phone him or her to discuss the advertised product or service. To accomplish this, the user selects the ad call icon disposed proximate the ad of interest, enters an appropriate phone number, receives confirmation of the call request, and awaits the phone call from the ad representative (150). The system (100) then determines the call center (140) to which the request is to be sent based on the ad's contact information. The ad representative (150) calls the user at the phone number listed and discusses the product or service advertised.

Referring now to FIG. 2, there is shown a flow chart (200) exemplifying control logic embodying features of a method for providing advertisement lead calling in accordance with principles of the present invention. The advertisement lead calling control logic (200) can be implemented as an algorithm on a general purpose computing platform or other suitable microprocessor-based system.

The advertisement lead calling control logic (200) can leverage the ability of a computer platform to spawn multiple processes and threads by processing data simultaneously. The speed and efficiency of the advertisement lead calling control logic (200) is greatly improved by instantiating more than one process to implement a phone conversation between the user and the ad representative (150). However, one skilled in the art of programming will appreciate that use of a single processing thread may also be utilized and is within the scope of the present invention.

The advertisement lead calling control logic (200) process flow of the present embodiment begins at step 202, where an advertisement is received from the advertisement publishing service (130) and the contact information contained in the advertisement is parsed. In one embodiment, the advertisements are received as an XML transaction. In a second embodiment, the advertisements are received as a JSON transaction. In a third embodiment, the advertisement information parsed is contact information for the advertiser. The contact information can include entries such as an e-mail address or generated e-mail address alias (for privacy), instant messaging address, text messaging number, VoIP Internet number, and other suitable contact information. In a fourth embodiment, the advertisement contains contact information associated with the advertiser. The contact information can include entries such as an e-mail address or generated e-mail address alias (for privacy), instant messaging address, text messaging number, VoIP Internet number, and other suitable contact information. In a fifth embodiment, the advertiser may elect to provide the contact information of a call center, which can provide information relevant to the advertisement. The logic then proceeds to step 204.

At step 204, code is generated to display the ad call icon in the application proximate the advertisement. In one embodiment, the icons associated with the advertisement are disposed below the advertisement. The logic then proceeds to step 206.

At step 206, the user is prompted to enter her call request information. The user selects an ad call icon disposed proximate the ad and a first pop-up window prompts the user to enter her call request information, such as name, phone number, requested call time, time zone, and other relevant call request information. The logic then proceeds to step 208.

At step 208, the method receives and parses the user contact information. The logic then proceeds to step 210.

At step 210, the call request is generated. After the user enters a valid phone number, the call request module (104) generates a call request having the call request information and the ad identification number. In one embodiment, an XML transaction is generated having the call request. In a second embodiment, a JSON transaction is generated having the call request. In a third embodiment, a plain-text message is generated having the call request. In a fourth embodiment, a text message is generated having the call request. In a seventh embodiment, the call center (140) can be an advertiser's phone number. In one embodiment, a first pop-up window pops up in the web-browser (110). The logic then proceeds to step 212.

At step 212, the call request is transmitted to the call center (140). The call request can be transmitted according to the transmission preference listed in the contact information associated with the ad. In one embodiment, the call request is transmitted to the call center (140) via a text message. In a second embodiment, the call request is transmitted to the call center (140) via e-mail. In a third embodiment, the call request is transmitted to the call center (140) via a network transfer protocol. In a fourth embodiment, the call request is transmitted to the call center (140) via a network transfer protocol based on a data request from another application. In a fifth embodiment, the data request can be the GET command or other suitable transfer request command. In a sixth embodiment, the call center (140) listed in the contact information associated with the ad is the destination of the call request. The logic then proceeds to step 214.

At step 214, the user is notified that the call request was transmitted to the call center (140). In one embodiment, a second pop-up window is displayed in web-browser (110) summarizing the call request details and notifying the user that the call request was successfully transmitted or pending transmission.

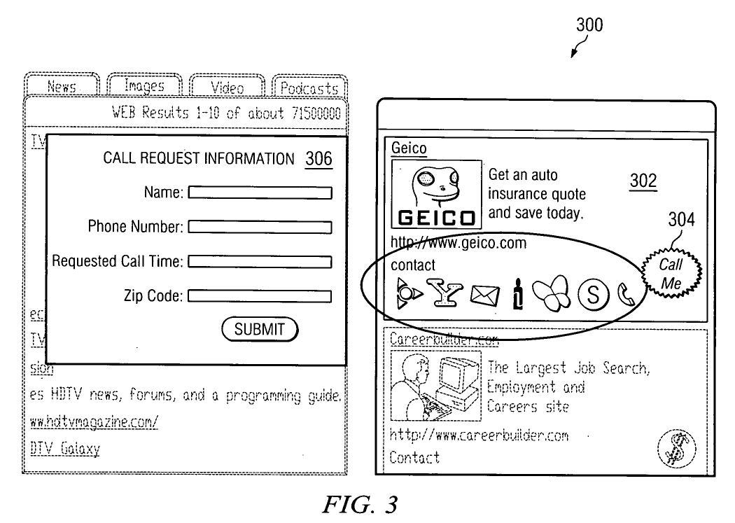

Referring now to FIG. 3, there is shown at 300 a screen shot of a web-browser (110) rendering an advertisement (302), an ad call icon (304), associated with the advertisement, and a first pop-up window (306), in accordance with principles of the present invention. In one embodiment, the ad call icon (304) can generate a call request requesting that the ad representative (150) calls the user regarding the ad when the user selects the ad call icon (304). In a second embodiment, the user provides information related to her call request in the first pop-up window (306) and submits the call request information, thereby requesting that the ad representative (150) call her.

The invention may be embodied in other specific forms without departing from the spirit or essential characteristics thereof. The present embodiments are therefore to be considered in all respects as illustrative and not restrictive. Accordingly, the scope of the invention is established by the appended claims rather than by the foregoing description. All changes, which come within the meaning and range of equivalency of the claims are therefore intended to be embraced therein. Further, the recitation of method steps does not denote a particular sequence for execution of the steps. Such method steps may therefore be performed in a sequence other than that recited unless the particular claim expressly states otherwise.

I claim:

1. A method for providing, in a networked environment, advertisement lead calling to allow a user to obtain additional information concerning advertised goods or services from an advertiser or the advertiser's designated representative, wherein the user's browser displays at least one advertisement, the method steps comprising:
providing an ad call icon for at least one advertisement, wherein the icon is located proximate the advertisement, and wherein the icon is capable of providing an indication of the user's desire to obtain information regarding the advertisement;
accepting a request for more information from the user via the ad call icon;
prompting the user for the user's contact information; and
providing the advertiser or the advertiser's designated representative with the user's contact information.

2. The method of claim 1, the method steps further comprising:
receiving an advertisement file for display in the user's browser; and
parsing the advertisement file to obtain information regarding contact information concerning the advertiser or the advertiser's designated representative.

3. The method of claim 1, the method steps further comprising:
generating a call request message, wherein the message comprises the user's contact information and advertisement identification information; and
providing the advertiser or the advertiser's designated representative with the call request message.

4. The method of claim 3, the method steps further comprising:
notifying the user of the status of the call request message.

5. A computer software program tangibly embodied in a computer readable medium, the program including machine-readable instructions executable by a computer processor to perform a method for providing, in a networked environment, advertisement lead calling to allow a user to obtain additional information concerning advertised goods or services from an advertiser or the advertiser's designated representative, wherein the user's browser displays at least one advertisement, the program steps comprising:
providing an ad call icon for at least one advertisement, wherein the icon is located proximate the advertisement, and wherein the icon is capable of providing an indication of the user's desire to obtain information regarding the advertisement;
accepting a request for more information from the user via the ad call icon;
prompting the user for the user's contact information; and
providing the advertiser or the advertiser's designated representative with the user's contact information.

6. The computer software program of claim 5, the program steps further comprising:
receiving an advertisement file for display in the user's browser; and
parsing the advertisement file to obtain information regarding contact information concerning the advertiser or the advertiser's designated representative.

7. The computer software program of claim 6, the program steps further comprising:
generating a call request message, wherein the message comprises the user's contact information and advertisement identification information; and
providing the advertiser or the advertiser's designated representative with the call request message.

8. The computer software program of claim 5, the program steps further comprising:
notifying the user of the status of the call request message.

9. A system for providing, in a networked environment, advertisement lead calling to allow a user to obtain additional information concerning advertised goods or services from an advertiser or the advertiser's designated representative, wherein the user's browser displays at least one advertisement, the system comprising:
an advertisement contact module, wherein the advertisement contact module parses received advertisement data to obtain contact information for the advertiser or the advertiser's designated representative;
a call request module, wherein the call request module receives the user's contact information and generates a call request comprising the user's contact information and advertisement identification information; and
a request transmission module, wherein the request transmission module transmits the call request to the advertiser or the advertiser's designated representative.

10. The system of claim 9 wherein the call request module causes a pop-up window to be displayed in the user's browser and wherein the user submits his or her contact information via this pop-up window.
